(19) United States
(12) Patent Application Publication
(10) Pub. No.: US 2005/0230928 A1
(43) Pub. Date: Oct. 20, 2005

(54) Power assisted hand truck

(76) Inventor: Keith Raney, St. Petersburg, FL (US)

Correspondence Address: BAY AREA INTELLECTUAL PROPERTY GROUP, LLC, PO BOX 210459, SAN FRANCISCO, CA, 94121-0459, US

(21) Appl. No.: 10/826,444

(22) Filed: Apr. 15, 2004

(51) Int. Cl. B62D 51/06

(52) U.S. Cl. 280/19.1

(57) ABSTRACT

A power assisted hand truck is provided, which includes a generally vertically oriented rigid frame having a top end, a bottom end, a front load receiving side, a rear side, and a load bearing member joined to the front load receiving side of the frame. This hand truck includes a pair of hand truck wheels rotatably joined laterally towards the bottom end of the frame so that the frame, and thus the hand truck, can be wheeled about. A motor is rigidly joined to the frame and is configured to rotate a power assistance wheel, which is rotatably joined to the frame towards the bottom end of the back side such that power assisted translational motion is imparted to the frame when both the motor and the power assistance wheel are engaged. Thus, the user can engage this power assistance system to significantly reduce his or her work required to push a heavy load on the hand truck, especially when moving the heavy load up inclines. Some embodiments locate the power assistance wheel in a generally centered position between the pair of hand truck wheels such that load balancing stability is improved.

### FIELD OF THE INVENTION

The present invention relates generally to hand trucks for use in manually handling and moving relatively heavy loads. More particularly, the invention relates to hand trucks with powered wheels that assist the operator moving relatively heavy loads.

### BACKGROUND OF THE INVENTION

Hand trucks and dollies including permanently mounted wheeled supports have long been used to assist people in manually moving and manipulating heavy objects such as furniture, appliances, food, beverage, shipping/moving containers, and the like. Typically, those of the fixedly attachable type comprise a support frame movably supported on a pair of wheels together with means for securing the device to a lower portion of the load such as to a dependent flange. The standard hand truck types, which are not fixedly secured, have commonly had an upright back support mounted to wheels with a short bottom flange or foot formed at a right angle to the upright support. By placing the bottom of a load on the foot and tilting the hand truck so that a side of the load rests against the upright support, the load may be lifted from a supporting floor for movement. The operator then pulls back on the handle located that the top of the hand truck and pivots the load on the two wheels typically located at the bottom of the hand truck. The operator then applies both vertical and horizontal pressure to the handle to make the hand truck move forward and to balance the load.

When using a standard hand truck to transfer heavy objects the operator must balance the angle based on the incline and terrain and apply additional force. To help balance the proper angle others have added two bars, which are attached near the base of the handle and have wheel attached at the bottom. The operator simply positions the support bars into a 45 degree angle. When objects are loaded and the operator pulls back on the handle the load is balanced on the two support bars. Carrying heavy loads or walking long distances requires a significant amount of energy. To provide assistance in moving the hand truck known methods have added gears and electric motors to the standard hand truck as implemented, for example, by U.S. Pat. No. 6,039,332 ('332). In '332, a motor is used to drive the axle spindles of the standard hand truck wheels either to the right or left depending upon the direction selected by a controlling switch. While useful in some situations, in practice, such integrated power assist mechanisms are often costly to implement into at manufacturing time due to tedious non-standard mechanisms, which also makes them impractical to be retrofitted onto standard hand trucks. Furthermore, such approaches still place an undue burden on the operator to balance the load using the hand truck handle. Other known approaches seek to address the load balancing problem, where U.S. Pat. Nos. 6,530,740 ('740) and 4,091,942 are examples. In '740, load balancing is handled by support poles that extend downward from each side of the standard hand truck frame towards the ground where they have wheel attached for supporting a heavy load at certain angle with respect to the ground. Among other drawbacks, such configurations make the resulting hand truck more difficult to manage, especially through tight turns and over uneven surfaces.

In view of the foregoing, there clearly is a need for improved techniques for efficiently providing both power assistance and load balancing to standard hand trucks. It would also be desirable if such a solution is capable of being economically retrofitted onto preexisting standard hand trucks.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a rear, exploded view of a hand truck configured according to an embodiment of the present invention;

FIG. 2 illustrates a rear perspective view of a hand truck configured according to an embodiment of the present invention;

FIG. 3 shows a rear view of a hand truck and the relative position of the powered drive wheel according to an embodiment of the present invention;

FIG. 4 is a side perspective view of a hand truck configured according to an embodiment of the present invention in its engaged orientation;

FIG. 5 illustrates a rear, exploded view of a hand truck configured according to a hub motor embodiment of the present invention;

FIG. 6 illustrates a rear perspective view of a hand truck configured according to a hub motor embodiment of the present invention;

FIG. 7 shows a rear view of a hand truck and the relative position of the powered drive wheel according to a hub motor embodiment of the present invention; and

FIG. 8 is a side perspective view of a hand truck configured according to a hub motor embodiment of the present invention in its engaged orientation.

Unless otherwise indicated illustrations in the figures are not necessarily drawn to scale.

### SUMMARY OF THE INVENTION

To achieve the forgoing and other objects and in accordance with the purpose of the invention, an improved power assisted hand truck is provided.

In one embodiment of the present power assisted hand truck invention, a power assisted hand truck is provided, which includes a generally vertically oriented rigid frame having a top end, a bottom end, a front load receiving side, a rear side, and a load bearing member joined to the front load receiving side of the frame. This hand truck includes a pair of hand truck wheels rotatably joined laterally towards the bottom end of the frame so that the frame, and thus the hand truck, can be wheeled about. A motor is rigidly joined to the frame and is configured to rotate a power assistance wheel, which is rotatably joined to the frame towards the bottom end of the back side such that power assisted translational motion is imparted to the frame when both the motor and the power assistance wheel are engaged. Thus, the user can engage this power assistance system to significantly reduce his or her work required to push a heavy load on the hand truck, especially when moving the heavy load up inclines. Some embodiments locate the power assistance wheel in a generally centered position between the pair of hand truck wheels such that load balancing stability is improved.

In some alternate, embodiments of present invention, the motor is configured to rotate the power assistance wheel by driving a gearbox, which gearbox is configured to transmit rotational motion from the motor to a power assistance axle that is joined to the power assistance wheel such that rotational motion is imparted to the power assistance wheel when the motor is engaged. However, in other embodiments, power assistance wheel axle is, instead, rigidly joined to the frame and rotatably joined to the power assistance wheel, whereby the motor is a hub motor configured to directly rotate the power assistance wheel about the power assistance wheel axle such that rotational motion is imparted to the power assistance wheel when the motor is engaged. The hub motor may also include a built-in mechanical brake in some applications.

The motor is an electric motor in some embodiments and is configured to receive power from a battery, which is included on the power assisted hand truck. To more effectively control the motion of the present power assisted hand truck, some embodiments include a motor control module that is configured to control the rotational motion imparted to the power assistance wheel by the electric motor, the motor control module being further configured to both receive a rotational motion command from a user and deliver the necessary signals to the electric motor to rotate the power assistance wheel substantially corresponding to the rotational motion command. The rotational motion command, in some embodiments, can result in a variable or fixed rotational speed to the power assistance wheel in the forward or reverse rotational directions.

In an aspect of the present invention, the power assistance wheel is configured such that it engages the ground when the power assisted hand truck is pivotally tilted in the rear direction at a certain tilt engagement angle. Typically, a tilt engagement angle of approximately 45 degrees relative to level ground is desirable.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments.

The present invention is directed towards assisting hand truck operators in the moving and balancing of heavy objects across relatively flat surfaces or inclines.

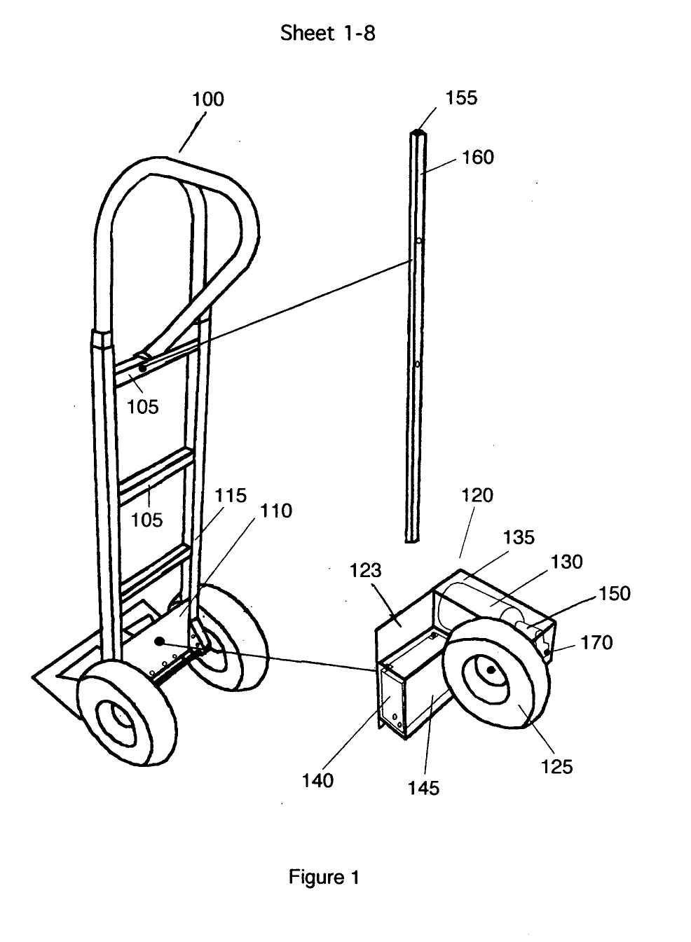

In one aspect of the present invention, a hand truck may be configured according to an embodiment of the present invention as shown in the rear, exploded view of FIG. 1.

In the figure, a hand truck 100 has, or is made to have, a cross support 105, and a lower mounting plate 110. In some alternative embodiments, cross support 105 may not be need and is optional as described below. A power assist module 120 is fixedly joined to lower mounting plate 110 in a multiplicity of known ways, by way of example and not limitation, bolting or welding them together. In some alternative embodiments lower mounting plate 110 may not be required when those skilled in the art determine that power assist module 120 may be safely and robustly mounted in other known ways to hand truck 100, by way of example and not limitation, by welding or bolting it to a hand truck frame 115.

Power assist module 120 comprises mechanical joining of a power assist module back plate 123, a power assist wheel 125, a power assist motor 130 housed in a motor box 135, and a power assist power source 140 housed in a power source box 145, and a power assist motor gearbox 150. Power assist power source 140 may be any suitable power source to drive power assist motor 130. For example, if power assist motor 130 is a 12 volt electrical motor, then power assist power source 140 would be selected to a 12 volt battery, preferably of the rechargeable type, of suitable amperage to drive power assist motor 130 for enough time under load and be of suitable dimensions to fit into power source box 145. Likewise, those in the art will know how to appropriately select power assist motor 130 and power assist motor gearbox 150 to provide the drive power and speed required for the particular application.

Hand truck 100 is further provided with a power assist actuation switch 155, which is located conveniently for use by the operator to appropriately activate power assist module 120. The power assist wires (not shown) that conductively connect power assist actuation switch 155 to a motor control circuit (not shown) may be protectively routed through conduit 160, which conduit may be fixedly attached to hand truck 100 on cross support 105 or any other suitable location according to known methods in the art. It should be appreciated that some applications may not require conduit 160 and, instead, alternate embodiments may arrange and attach the power assist wires and power assist actuation switch 155 in a multiplicity of known configurations depending on the application requirements. Those skilled in the art will readily know how to appropriately select and configure power assist actuation switch 155 is depending on the application and functionality desired. By way of example, and not limitation, in some embodiments, power assist actuation switch 155 is a single position, momentary on switch, which provides a measure of additional safety and convenience in certain applications. Yet other embodiments may require a switch capable of dual position, momentary operation to actuate, for example, power assist motor 130 in the forward and reverse directions thereby permitting the operator to use the power assistance capability of the present invention both the in forward and backward direction as needed. Motor control circuits are readily available that can properly drive and control power assist motor 130 according to appropriate signals from power assist actuation switch 155.

When required in certain embodiments, a power source recharge port 170 may be located in any convenient place, which is preferable to manufacturing and/or operator usage considerations. In such embodiments of the present invention, a battery charger is also provided for recharging, through power source recharge port 170, power assist power source 140 when it is a rechargeable battery.

In the present embodiment, power assist module 120 is joined via power assist module back plate 123 to lower mounting plate 110 by known means; however, it is contemplated that in alternate embodiments and depending on the application requirements, a skilled artisan may appropriately configure power assist module 120 in size and location in a multiplicity of known ways such that it can be robustly (relative to at a certain maximum load) joined to hand truck 100 while safely and effectively performing its power assist and load balancing functions in accordance with the attendant principles of the present invention.

The present electro-mechanical system according to the present invention is functionally connected and operated as follows. To activate power assist wheel 125 the operator actuates power assist actuation switch 155 which signals the motor control circuit (not shown) to provide power from power assist power source 140 to power assist motor 130, which transmits is rotational energy to power assist motor gearbox 150 and in turn power assist wheel 125. In the depicted embodiment, power assist motor 130 powers a right angle power assist motor gearbox 150 of the worm gear type; however, it is contemplated that those in the art, depending of the application requirements, may implement other known suitable configurations or gear types. By way of example and not limitation, power assist motor 130 could, instead, be arranged inline with power assist wheel 125 and use an inline gear system to efficiently transfer rotational energy from power assist motor 130 to power assist wheel 125. Yet other embodiments may not have a separate gearbox and, instead, include the gearbox within the motor.

The present embodiment may be constructed of a multiplicity of known materials that provide sufficient structural strength, and may assembled in accordance with the present teachings via a multiplicity of known joining and mounting techniques. Those in the art are familiar with the proper selection of materials and assembly techniques to carry out the present teachings. By way of example and not limitation, the structural elements including power assist module back plate 123, motor box 135, power source box 145 may be made of a metal, such as aluminum or steel, of a suitable gauge and may all be joined by nuts and bolts for ease of maintaining internal components.

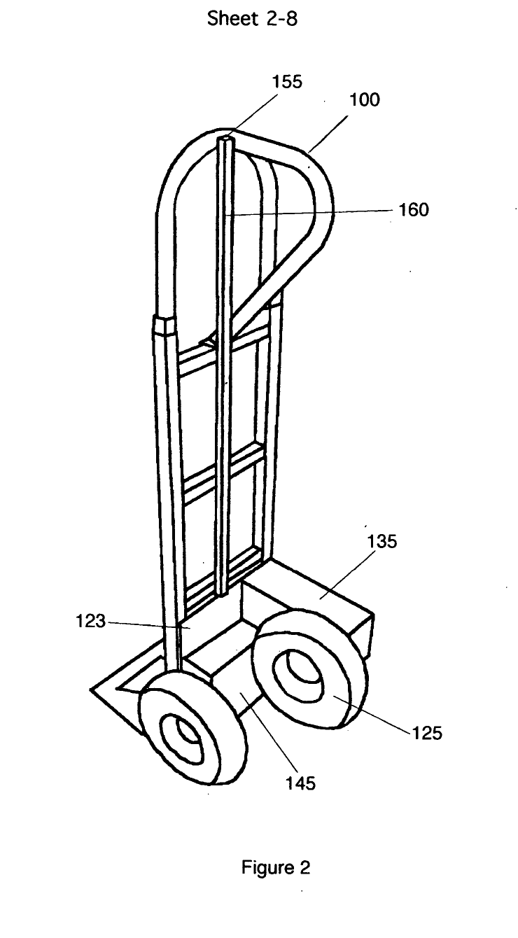

FIG. 2 shows a rear perspective view of hand truck 100 in the upright orientation according to an embodiment of the present invention wherein power assist wheel 125 preferably does not make contact to the ground. Typically, the hand truck operator will place the load onto hand truck 100 in this orientation and with power assist motor 130 deactivated by having power assist actuation switch 155 is an off position.

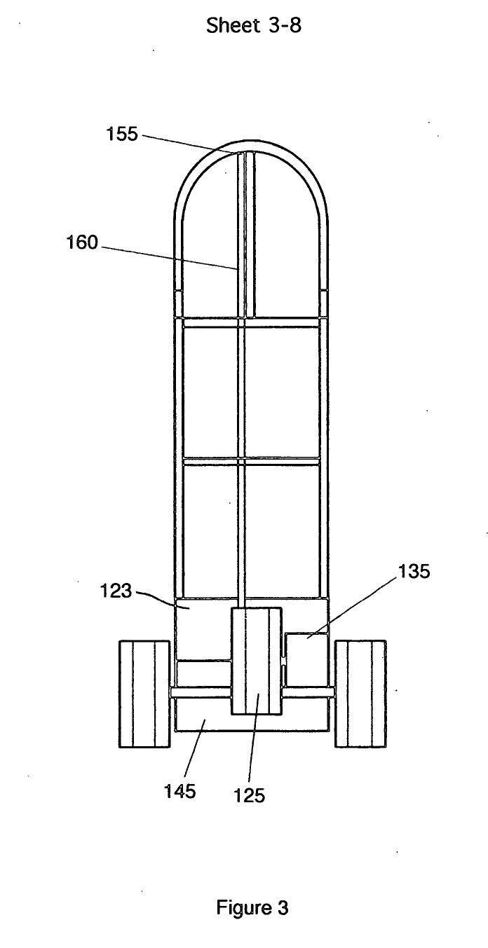

FIG. 3 illustrates a rear view of hand truck 100. The placement of power assist module 120 (not shown), and hence, the distance from the rolling surface of power assist wheel 125 in the upright position, determines the angle that hand truck 100 will make with respect to the rolling surface when it is tilted backwards during engagement. Those skilled in the art will know the appropriate angle desired for their particular application, and will accordingly know how configure power assist module 120 to result in the desired engagement angle to the rolling surface. When the rolling surface is level ground, typically, an engagement angle of 45 degrees is optimal. When the rolling surface is at a substantial incline relative to level ground, other engagement angles may be more optimal and the skilled designer will know the appropriate engagement angle, and hence power assist module 120 placement height, that performs optimally over the full range of expected usage.

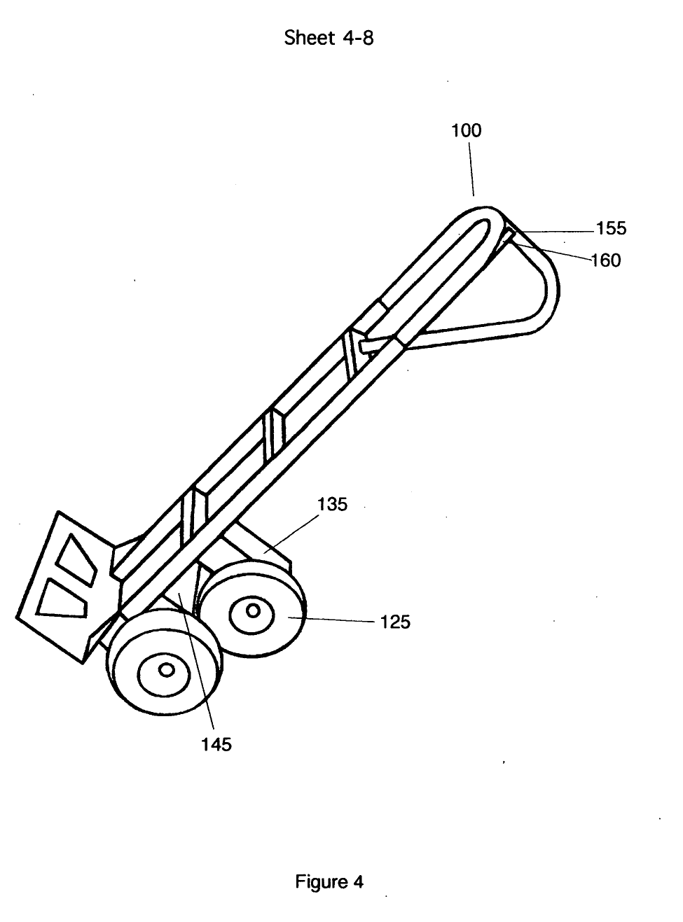

FIG. 4 shows a side perspective view of hand truck 100 configured according to an embodiment of the present invention in its tilted back, or engaged orientation, where power assist wheel 125 makes frictional contact with the rolling surface (not shown). Typically the operator will appropriately place the relatively heavy load on the base of hand truck 100 while it is in the upright position, and then tilt backwards hand truck 100 by pivoting on the two hand truck tires until power assist wheel 125 makes frictional contact with the rolling surface and then activate power assist actuation switch 155 thereby activating power assist motor 130 to drive power assist wheel 125 to move hand truck 100 in the desired direction with a minimal of effort by the operator. Power assist wheel 125 performs the dual function of providing power assistance and load stabilization to enable to operator to relatively easily move and balance the load. The size of power assist wheel 125 is suitably chosen according to known principles in the art according to the application, where a diameter of 8 inches is known to be effective in certain embodiments. To control the conveyance of hand truck 100 the operator activates and deactivates power assist actuation switch 155 to engage and disengage, respectively, power assist motor 130 and intern the motion of power assist wheel 125. Although power assist motor gearbox 150 may be of any suitable type, when it is a worm drive type of gearbox power assist wheel 125 will tend to act as a break power assist motor 130 is disengaged as it is stopped from freely turning after the drive power has been removed.

In some embodiments of the present invention, power assist module 120 (FIG. 1) is aftermarket add-on component that is configured onto a standard hand truck as taught by the described foregoing embodiments. Those skilled in the art will appreciate that the present invention may be configured to be relatively easily removed after installation, or, if desired, be joined relatively permanently with the standard hand truck. In yet other embodiments, the present invention is completely formed at the time of manufacturing according to the teachings of the present invention.

To further improve the power assistance capability provided by the foregoing teachings, other embodiments of the present invention replace the two hand truck tires with hub motors. Hub motors have the tire, rim, brake and motor build as one component. Those in the art will appreciate that this approach may be applied to either a standard two-wheel hand truck or a collapsible four-wheel hand truck. The collapsible hand truck has two hub motor drive wheels in the front and two small casters supporting the rear portion of the hand truck, converting to a four-wheel hand truck. The user simply presses the on/off button and directs the hand truck in the desired direction. These embodiments may also include built-in mechanical brakes.

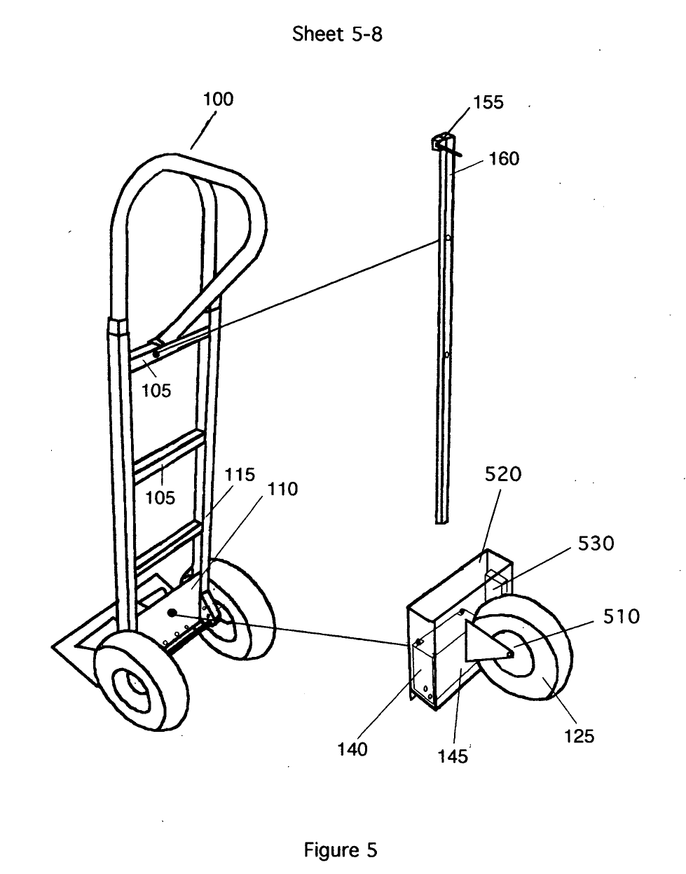

An hub motor embodiment of the present invention is illustrated by way of example in FIG. 5 from a rear, exploded perspective view. In the Figure, a hub motor 510 is provided, which replaces the need for a separate motor and gear assembly shown in FIGS. 1-4. Preferably, hub motor 510 is built into the hub of power assist wheel 125 and optionally includes an electric brake (not shown). Hub motor 510 is fixedly attached to hub power assist module 520 such that it can safely bare its intended maximum load. For example, hub motor 510 may be connected to 2 brackets mounted on the back of power source box 145. In some applications, power assist wheel 125 is a solid tire, yet other suitable tire options will be readily known to those in the art. The present embodiment allows for a more compact and efficient power assistances in many common applications and situations. Hub motors are commonly available that when configure onto hand truck 100 in accordance with the present teachings, a significant amount of weight may be carried under power assistance. By way of example, and not limitation, in the configuration of FIG. 5, a typically available hub powered wheel is capable of caring and pushing up to 700 lbs of product on hand truck 100.

Hub power assist module 520 is equipped with an electronic motor controller 530, capable of suitably controlling the forward and reverse drive of hub motor 510. In a preferred embodiment, motor controller 530 provides variable power to hub motor 510 by way of a power assist actuation switch 155, which may be implemented potentiometer and controller level that is appropriately is connected to motor controller 530. In some typical application of the present embodiment, a 5 k ohms potentiometer connected to a common 24-volt electronic controller suitably provides variable power, and, hence, speed, to a 24-volt hub motor. In this 24-volt example, power assist power source 140 may be 2 12-volt batteries serially connected. In some embodiments, motor controller 530 is configured to also provide electronic braking to hand truck 100 to safely come to a stop. Power source box 145, preferably contains the appropriate power source configuration to power electronic motor controller 530 and hub motor 510, and electronic motor controller 530. However, other embodiments are contemplated where these components may be, otherwise, suitably located depending on the application.

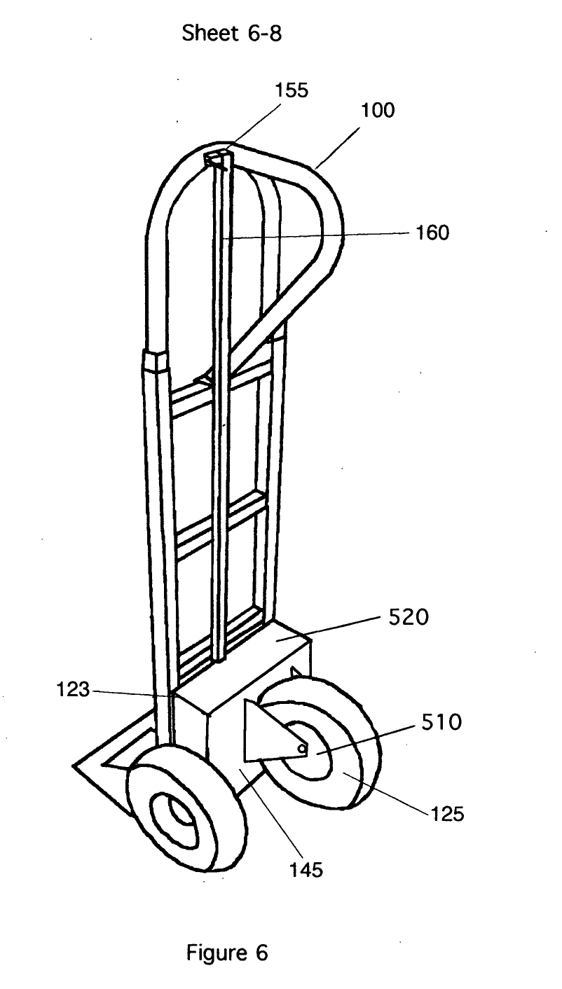

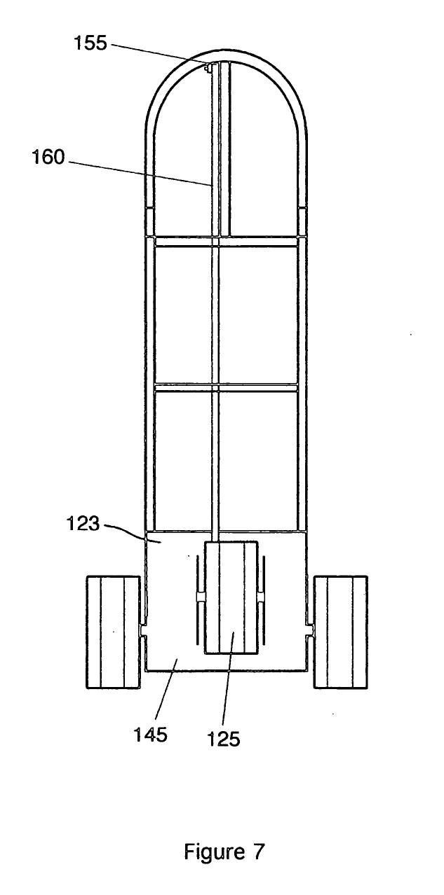

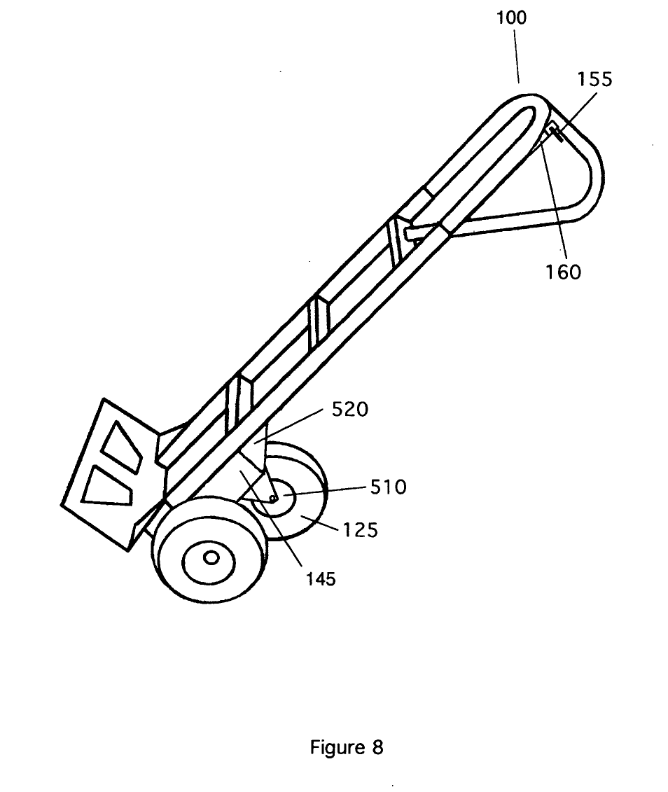

FIG. 6 illustrates a rear perspective view of a hand truck configured according to the present hub motor embodiment. FIG. 7 shows a rear view of a hand truck and the relative position of the powered drive wheel according to the present hub motor embodiment. FIG. 8 is a side perspective view of a hand truck configured according the present hub motor embodiment of the present invention in its engaged orientation.

Having fully described at least one embodiment of the present invention, other equivalent or alternative methods of implementing hand truck power assistance and load balancing according to the present invention will be apparent to those skilled in the art. For example, although the embodiments shown were directed to a single centered, powered wheel, those skilled in the art will recognize a multiplicity of alternative configurations, such as, by way of example, and not limitation, embodiments implementing, instead, two symmetrically disposed rear, powered wheels. Hence, these alternative embodiments are contemplated as within the scope of the present invention. It should, therefore, be understood that the invention has been described above by way of illustration, and the specific embodiments disclosed are not intended to limit the invention to the particular forms disclosed. The invention is thus to cover all modifications, equivalents, and alternatives falling within the spirit and scope of the following claims.

1. A power assisted hand truck, comprising:
a generally vertically oriented rigid frame having a top end, a bottom end, a front load receiving side, and a rear side;
a load bearing member joined to the front load receiving side of the frame;
a pair of hand truck wheels rotatably joined laterally towards the bottom end of the frame such that the frame can be rolled about; and
a motor rigidly joined to the frame, the motor being configured to rotate a power assistance wheel that is rotatably joined to the frame towards the bottom end of the back side such that power assisted translational motion is imparted to the frame when both the motor and the power assistance wheel are engaged.

2. The power assisted hand truck of claim 1 wherein the power assistance wheel is generally centered between the pair of hand truck wheels such that load balancing stability is improved.

3. The power assisted hand truck of claim 1 wherein the motor is configured to rotate the power assistance wheel by driving a gearbox, which gearbox is configured to transmit rotational motion from the motor to a power assistance axle that is joined to the power assistance wheel such that rotational motion is imparted to the power assistance wheel when the motor is engaged.

4. The power assisted hand truck of claim 1, further comprising a power assistance wheel axle that is rigidly joined to the frame and rotatably joined to the power assistance wheel, whereby the motor is a hub motor configured to directly rotate the power assistance wheel about the power assistance wheel axle such that rotational motion is imparted to the power assistance wheel when the motor is engaged.

5. The power assisted hand truck of claim 4, wherein the hub motor comprises a built-in mechanical brake.

6. The power assisted hand truck of claim 1, wherein the motor is an electric motor configured to receive power from a battery, whereby said power assisted hand truck further comprises said battery.

7. The power assisted hand truck of claim 6, further comprising a motor control module that is configured to control the rotational motion imparted to the power assistance wheel by the electric motor, the motor control module being further configured to both receive a rotational motion command from a user and deliver the necessary signals to the electric motor to rotate the power assistance wheel substantially corresponding to the rotational motion command.

8. The power assisted hand truck of claim 7, wherein the rotational motion command essentially corresponds to a variable or fixed rotational speed of the power assistance wheel in the forward or reverse rotational directions.

9. The power assisted hand truck of claim 1, wherein the power assistance wheel is configured such that it engages the ground when the power assisted hand truck is pivotally tilted in the rear direction at a certain tilt engagement angle.

10. The power assisted hand truck of claim 9, wherein the tilt engagement angle is approximately 45 degrees on level ground.

11. A power assisted hand truck, comprising:
a generally vertically oriented rigid frame having a top end, a bottom end, a front load receiving side, and a rear side;
a load bearing member joined to the front load receiving side of the frame;
a pair of hand truck wheels rotatably joined laterally towards the bottom end of the frame such that the frame can be rolled about; and
rotational means to rotate a power assistance wheel means such that translational motion is imparted to the frame when both the rotational means and the power assistance wheel means are engaged.
